(19) United States
(12) Patent Application Publication
(10) Pub. No.: US 2012/0150488 A1
(43) Pub. Date: Jun. 14, 2012

(54) Number of steps counting apparatus, electronic apparatus, pedometer, and program

(76) Inventors: Shotaro Kamiyama, Chiba-shi (JP); Akira Takakura, Chiba-shi (JP)

(21) Appl. No.: 13/373,983

(22) Filed: Dec. 7, 2011

(30) Foreign Application Priority Data
Dec. 8, 2010 (JP) 2010-273991

(51) Int. Cl. G06F 15/00; G01C 22/00

(52) U.S. Cl. 702/160; 702/176

(57) ABSTRACT

The invention provides a number of steps counting apparatus, an electronic apparatus, a pedometer, and a program which achieve reduction of power consumption. In the pedometer having a walking detecting unit configured to output a walking signal indicating a walking state and a calculating unit configured to calculate the number of steps, the walking detecting unit repeats actions of operating for a first period and stopping for a second period during the operation of the pedometer.

### BACKGROUND OF THE INVENTION

1. Field of the Invention

The present invention relates to a number of steps counting apparatus, an electronic apparatus, a pedometer, and a program.

2. Description of the Related Art

Recent years, an electronic pedometer including an acceleration sensor integrated therein and having a system of being carried in a state of being accommodated in a clothes pocket or in a bag is known. In JP-A-2001-143048, there is a description of a pedometer configured not to continue counting for a certain period when a state in which vibrations which are determined as walking are not detected is continued.

However, in the technology described in JP-A-2001-143048, there is a drawback such that electric power is continuously consumed because detection is always performed as long as a user is walking.

### SUMMARY OF THE INVENTION

It is an aspect of the application to provide a number of steps counting apparatus, an electronic apparatus, a pedometer, and a program which achieve reduction of power consumption.

In order to solve the above-described problem, another aspect of the application is a number of steps counting apparatus including a number of steps counting unit configured to estimate the number of steps in a time period during which counting of the number of steps during walking is stopped, and add the estimated number of steps to a total number of steps.

In the number of steps counting apparatus described above, preferably, the number of steps counting unit counts the number of steps during a first period and stops counting of the number of steps during a second period, the first period and the second period being repeated alternately.

In the number of steps counting apparatus described above, preferably, the number of steps counting unit estimates the number of steps in a period when counting of the number of steps is stopped on the basis of the number of steps counted in the first period.

In the number of steps counting apparatus described above, preferably, the number of steps counting unit elongates the second period when the number of continuous steps are counted in a predetermined period.

In the number of steps counting apparatus described above, preferably, the number of steps counting unit displays a total number of steps obtained by adding the estimated number of steps to the number of steps in the first period.

According to another aspect of the invention, an electronic apparatus includes the number of steps counting apparatus described above.

According to another aspect of the application, a pedometer includes the number of steps counting apparatus described above.

Also, another aspect of the application is a program for causing a computer of the number of steps counting apparatus to execute a procedure, the procedure including: estimating the number of steps in a first period in which counting of the number of steps during walking is stopped, and adding the estimated number of steps to the total number of steps.

According to the application, reduction of power consumption is achieved.

### BRIEF DESCRIPTION OF THE DRAWINGS

FIG. 1 is a schematic block diagram showing a configuration of a pedometer according to an embodiment of the invention;

FIG. 2 is an explanatory drawing showing an example of a walking detection process according to the embodiment; and

FIG. 3 is a flowchart showing an example of an action of the pedometer according to the embodiment.

### DESCRIPTION OF THE PREFERRED EMBODIMENTS

Referring now to the drawings, an embodiment of the invention will be described in detail.

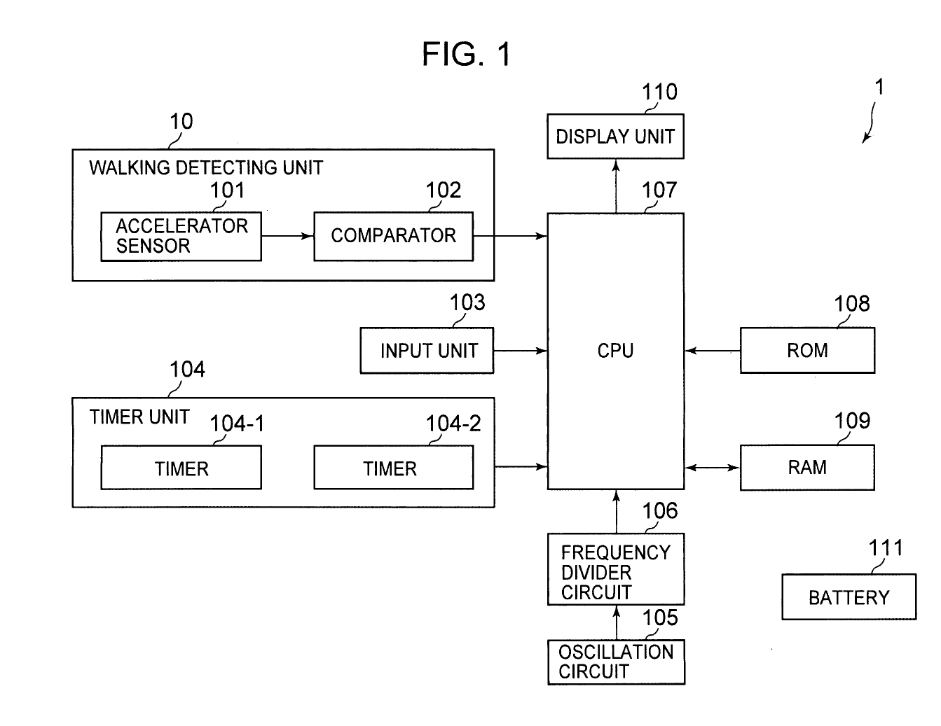

FIG. 1 is a schematic block diagram showing a configuration of a pedometer 1 according to the embodiment of the invention. In FIG. 1, the pedometer 1 includes a walking detecting unit 10, an input unit 103, a timer unit 104-m (m=1, 2), an oscillation circuit 105, a divider circuit 106, a CPU (Central Processing Unit) (number of steps counting unit, calculating unit) 107, a read only memory (ROM) 108, a random access memory (RAM) 109, a display unit 110, and a battery 111. The walking detecting unit 10 includes an accelerator sensor 101 and a comparator 102.

The accelerator sensor 101 detects acceleration in association with a movement of a body of a user. The accelerator sensor 101 outputs an acceleration signal (analogue signal) indicating the magnitude of the detected acceleration to the comparator 102.

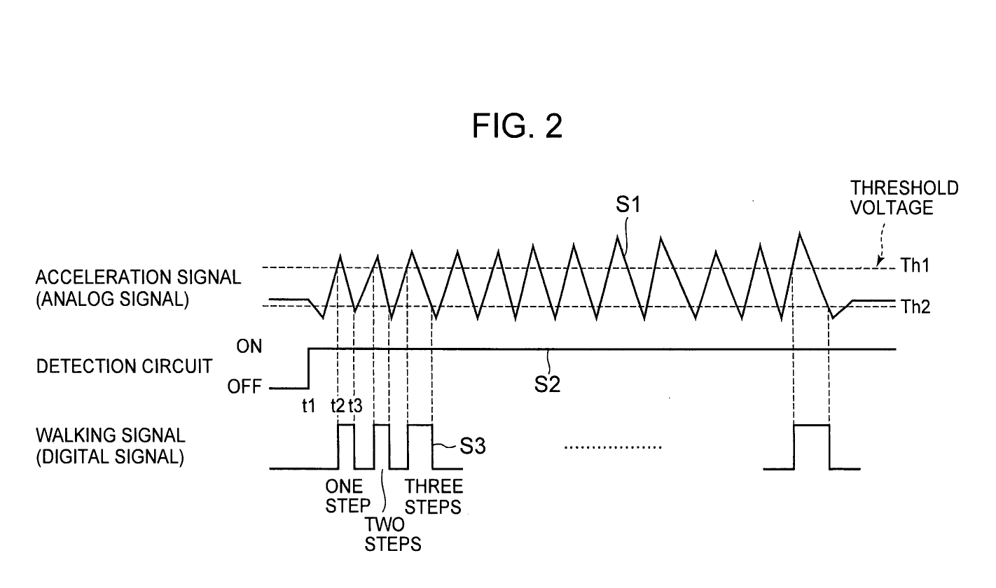

The comparator 102 is turned ON when the accelerator signal supplied from the accelerator sensor 101 exceeds a predetermined threshold voltage Th1, and outputs an raised walking signal (digital pulse) to the CPU 107 until the acceleration signal falls below a threshold voltage Th2 (>Th1) (see FIG. 2). In contrast, the comparator 102 is turned OFF when the signal supplied from the accelerator sensor 101 falls below the threshold voltage Th2, and outputs a fallen walking signal to the CPU 107 until the acceleration signal exceeds a voltage Th1. This walking signal is used for calculating the number of steps.

The accelerator sensor 101 and the comparator 102 (walking detecting unit 10) repeat activation and stop alternately under the control of the CPU 107. In other words, the walking detecting unit 10 detects the acceleration and outputs the walking signal while the walking detecting unit 10 is activated (first period: hereinafter, referred to as “uptime”). In contrast, the walking detecting unit 10 does not detect the acceleration and does not output the walking signal while the walking detecting unit 10 is stopped (second period: hereinafter, referred to as “downtime”).

The input unit 103 receives an input for activating the pedometer and other inputs from the user, and outputs signals for the received inputs to the CPU 107.

The timer unit 104 includes a timer 104-1 and a timer 104-2. The time period to be counted (referred to as “timer period”) by the timer 104-m (m=1, 2) is set by the CPU 107. The timer 104-m starts counting of the time period upon receipt of an input of a start trigger signal from the CPU 107. The timer 104-m determines whether or not the time period counted from a moment when an input of the start trigger signal is supplied exceeds the set timer period. As a result of determination, when it is determined that the counted time period exceeds the timer period, the timer 104-m outputs a signal indicating “high (H)” to the CPU 107. In contrast, when it is determined that the counted time period does not exceed the timer period, the timer 104-m outputs a signal indicating “low (L)” to the CPU 107.

The oscillation circuit 105 acquires an output of the signal from an oscillator such as a quartz resonator, and outputs the acquired signal to the divider circuit 106.

The divider circuit 106 outputs a clock signal obtained by dividing an input signal from the oscillation circuit 105 (reducing the frequency) according to a predetermined dividing ratio. The predetermined dividing ratio is a parameter determined to cause the divider circuit 106 to output clock signals within a range of a clock frequency at which the CPU 107 is operated. The divider circuit 106 counts the input oscillating signals from the oscillation circuit 105 with a counter circuit, and outputs a single digital pulse to the CPU 107 when the counted value reaches the value set on the basis of the dividing ratio.

The CPU 107 performs various kinds of arithmetic processing synchronously with the input clock signal from the divider circuit 106. For example, the CPU 107 activates the walking detecting unit 10 and stops the walking detecting unit 10.

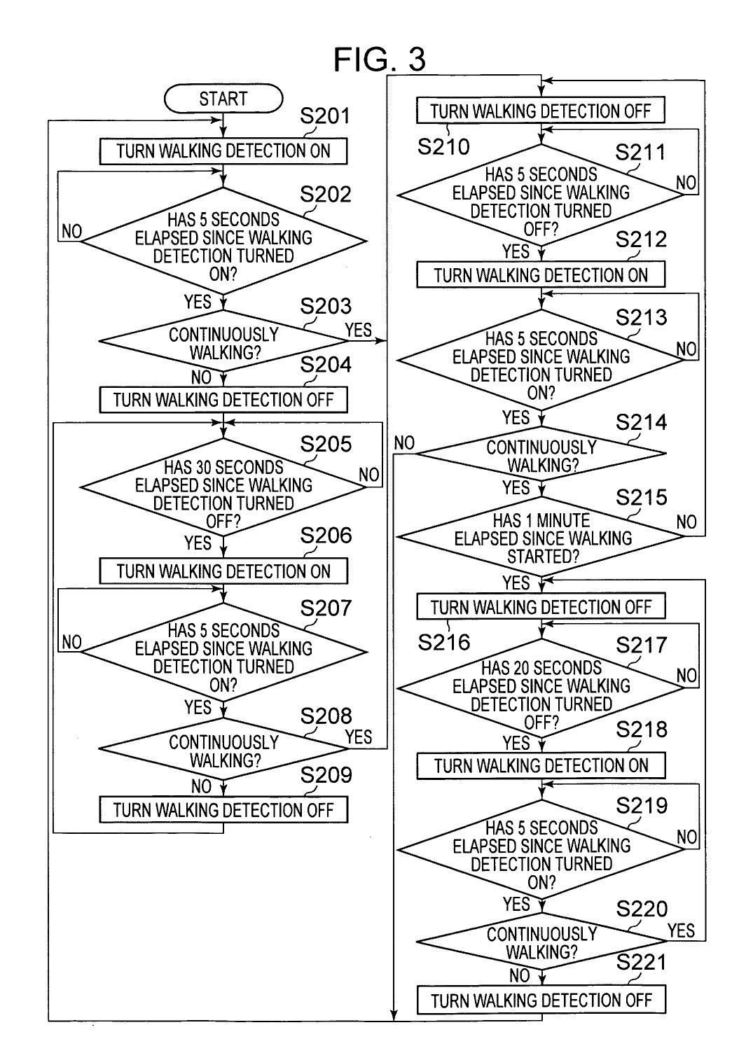

When the walking detecting unit 10 is activated, the CPU 107 determines whether or not the user has walked one step on the basis of the input walking signal from the comparator 102 (see FIG. 3). When the CPU 107 determines that the user has walked one step, the CPU 107 adds “1” to the total number of steps read out from the RAM 109 (referred to as “total number of steps”). The CPU 107 records the added number of steps in the RAM 109. This process is performed during the uptime. The process performed by the CPU 107, the accelerator sensor 101, and the comparator 102 during the uptime is referred to as “walking detection process”.

In contrast, when the walking detecting unit 10 is stopped, the CPU 107 estimates the number of steps during the time period when the walking detecting unit 10 is stopped on the basis of the number of steps detected during the uptime of the walking detecting unit 10. This process is performed during the downtime. The process performed by the CPU 107 during the downtime is referred to as “walking estimation process”.

When it is determined that the user has walked one step continuously during the predetermined time period, that is, the user has continued to walk, the CPU 107 elongates the time period to keep the walking detecting unit 10 stopped.

The CPU 107 generates display information including number of steps information indicating the total number of steps recorded by the RAM 109 and outputs the generated display information to the display unit 110. The CPU 107 generates the display information on the basis of programs or data recorded in the ROM 108 and the RAM 109, and outputs the generated display information to the display unit 110. The display information includes, for example, the total number of steps, consumed caloric values, target number of steps, number of steps required to reach a target caloric value to be consumed. Here, the target number of steps and the target caloric value to be consumed are information input to the input unit 103 by the user, and written in the RAM 109.

Detailed description about the action of the CPU 107 will be given below using a flowchart.

The ROM 108 records programs or data used by the CPU 107.

The RAM 109 records input data from the CPU 107.

The display unit 110 displays input display information from the CPU 107.

The battery 111 supplies drive power to respective parts of the pedometer 1.

FIG. 2 is an explanatory drawing showing an example of a walking detection process according to this embodiment. In this drawing, the lateral axis indicates time. A line designated by reference symbol S1 indicates a waveform of the voltage of the acceleration signal (referred to as “waveform S1”) . A line designated by reference symbol S2 indicates a state weather the walking detecting unit 10 is activated (ON) or stopped (OFF). A line designated by reference symbol S3 indicates a waveform of the voltage of the walking signal (referred to as “waveform S3”).

At a time “t1” in FIG. 2, the line designated by reference symbol S2 indicates that the walking detecting unit 10 is activated.

At a time “t2”, the waveform S1 indicates that the voltage of the acceleration signal is raised beyond the threshold voltage Th1. At the time “t2”, the waveform S3 indicates a risen walking signal.

At a time “t3”, the waveform S1 indicates that the voltage of the acceleration signal is fallen beyond the threshold voltage Th2 (<Th1). At the time “t3”, the waveform S3 indicates a fallen walking signal.

When both of the risen walking signal and the fallen walking signal are detected once, the CPU 107 determines that the user has walked one step.

Subsequently, the operation of the CPU 107 in this embodiment will be described.

FIG. 3 is a flowchart showing an example of an action of the pedometer 1 according to this embodiment.

(Step S201) The CPU 107 activates the walking detecting unit 10. The accelerator sensor 101 and the comparator 102 are activated (receive a supply of power), whereby the walking detection process is started (walking detection ON). The CPU 107 records the total number of steps at the time when the walking detection process is started (initial value of the total number of steps) recorded in the RAM 109 to the RAM 109. The CPU 107 adds “1” to the total number of steps recorded in the RAM 109 and renews every time when the user is determined to have walked one step on the basis of the input walking signal from the walking detecting unit 10. The CPU 107 generates the number of steps information indicating the total number of steps after the addition and causes the display unit 110 to display. The walking detection process is performed until the walking detection process is stopped (walking detection OFF).

The CPU 107 sets the value of the uptime (five seconds in this embodiment) to the timer 104-1. The CPU 107 outputs the start trigger signal to the timer 104-1. Accordingly, the timer 104-1 starts counting of the predetermined uptime. Subsequently, the procedure goes to Step S202.

(Step S202) The CPU 107 determines whether or not the output from the timer 104-1 is high (H) to determine whether or not the uptime (5 seconds) has elapsed since the counting is started in Step S201. When it is determined that the uptime is elapsed (Yes), the procedure goes to the process in step S203. In contrast, when it is determined that the uptime is not elapsed (No), the procedure goes back to the process in Step S202.

(Step S203) The CPU 107 reads out the total number of steps and the initial value of the total number of steps from the RAM 109. In general, the number of steps per minute when walking is approximately 100 BPM (beats per minute). In this embodiment, when the user makes six or more steps during five seconds, the CPU 107 determines that the user is continuously walking. When the value obtained by subtracting the initial value of total number of steps from the total number of steps (number of steps at the time of activation) is six or more, the CPU 107 determines that the user is continuously walking, and when the number of steps at the time of activation is smaller than 6, the CPU 107 determines that the user is not continuously walking. When it is determined that the user is continuously walking (Yes), the procedure goes to Step S210. In contrast, when the CPU 107 determines that the user is not continuously walking (No), the procedure goes to the process in Step S204.

In this embodiment, the CPU 107 determines that the user is continuously walking when the number of steps at the time of activation is 6 or more, and determines that the user is not continuously walking when the number of steps at the time of activation is smaller than 6. However, the criteria may be different from above, and may be changed such that the CPU 107 determines that the user is continuously walking when the number of steps at the time of activation is 4 or more in a case where the walking speed is low such as a case of aged persons, and is not continuously walking when the number of steps at the time of activation is smaller than 4. The input unit 103 may be used for changing the criteria.

(Step 204) The CPU 107 causes the walking detecting unit to stop the walking detection process. The walking detecting unit 10 stops the supply of power to the accelerator sensor 101 and the comparator 102, and stops the walking detection process (walking detection OFF). The CPU 107 sets the value of a first detection downtime (30 seconds in this embodiment) to the timer 104-1. The CPU 107 outputs the start trigger signal to the timer 104-1. Accordingly, the timer 104-1 starts counting of the predetermined first detection downtime. Subsequently, the procedure goes to Step S205.

(Step S205) The CPU 107 determines whether or not the output from the timer 104-1 is high (H) to determine whether or not the first detection downtime has elapsed since the counting is started in Step S204. When it is determined that the first detection downtime is elapsed (Yes), the procedure goes to Step S206. In contrast, when it is determined that the first detection downtime is not elapsed (No), the procedure goes back to the process in Step S205.

The processes from Step S206 to Step S208 are the same as the processes from Step S201 to Step S203. However, it is different in that the procedure goes to Step S209 when the result of determination in Step S208 is (No).

The CPU 107 causes the walking detecting unit 10 to stop the walking detection process. The walking detecting unit 10 stops the supply of power to the accelerator sensor 101 and the comparator 102, and stops the walking detection process (walking detection OFF).

In a series of steps from Step S201 to Step S209, the CPU 107 determines whether or not the walking action is started. When the walking action is not detected, an intermittent detection of the start of walking, which performs the walking detection process every 30 seconds for five seconds, is performed.

(Step 210) The CPU 107 causes the walking detecting unit to stop the walking detection process. The walking detecting unit 10 stops the supply of power to the accelerator sensor 101 and the comparator 102, and stops the walking detection. The CPU 107 sets the value of a second detection downtime (5 seconds in this embodiment) to the timer 104-1. The CPU 107 outputs a start trigger signal to the timer 104-1. Accordingly, the timer 104-1 starts counting of the predetermined uptime. Also, the CPU 107 sets the value of a stable walking determination time (1 minute in this embodiment) to the timer 104-2. The CPU 107 outputs the start trigger signal to the timer 104-2. Accordingly, the timer 104-2 starts counting of the predetermined stable walking determination time.

The CPU 107 reads out the total number of steps and the initial value of total number of steps recorded in the RAM 109, and calculates a value obtained by dividing the number of steps at the time of activation calculated from the total number of steps and the initial value of total number of steps by the uptime (average walking speed) . The CPU 107 multiplies the average walking speed by the time period from the timing when the walking detection process is stopped to the present to estimate the number of steps made from the timing when the walking detection process is stopped to the present. The CPU 107 adds “1” to the total number of steps recorded in the RAM 109 every time when the estimated number of steps increases by “1”. The CPU 107 records the total number of steps to the present in the RAM 109, and displays the same on the display unit 110. The CPU 107 generates the number of steps information indicating the total number of steps after the addition and causes the display unit 110 to display. The walking estimation process is performed until the walking detection process is started (walking detection ON) . Subsequently, the procedure goes to Step S211.

(Step S211) The CPU 107 determines whether or not the output from the timer 104-1 is high (H) to determine whether or not the second detection downtime has elapsed since the counting is started in Step S210. When it is determined that the uptime is elapsed (Yes), the procedure goes to Step S212. In contrast, when it is determined that the uptime is not elapsed (No), the procedure goes back to the process in Step S211.

The processes from Step S212 to Step S214 are the same as the processes from Step S201 to Step S203. However, it is different in that the procedure goes to Step S215 when the result of determination of the Step S214 is (Yes) and to Step S201 when the result is (No).

(Step S215) The CPU 107 determines whether or not the output from the timer 104-2 is high (H) to determine whether or not the stable walking determination time has elapsed since the counting is started in Step S210. When it is determined that the stable walking determination time is elapsed (Yes), the procedure goes to Step S216. In contrast, when it is determined that the stable walking determination time is not elapsed (No), the procedure goes back to Step S210.

In the processes from Step S210 to Step S215 described above, whether or not the walking continues for more than 1 minute (whether or not the user enters the stable walking state) is determined.

(Step 216) The CPU 107 causes the walking detecting unit to stop the walking detection process. The walking detecting unit 10 stops the supply of power to the accelerator sensor 101 and the comparator 102, and stops the walking detection. The CPU 107 sets a value of the downtime during stable walking (20 seconds in this embodiment) to the timer 104-1. The CPU 107 outputs a start trigger signal to the timer 104-1. Accordingly, the timer 104-1 starts counting of the predetermined uptime.

The CPU 107 reads out the total number of steps and the initial value of total number of steps recorded in the RAM 109, and calculates a value obtained by dividing the number of steps at the time of activation calculated from the total number of steps and the initial value of total number of steps by the uptime (average walking speed). The CPU 107 multiplies the average walking speed by the time period from the timing when the walking detection process is stopped to the present to estimate the number of steps made from the timing when the walking detection process is stopped to the present. The CPU 107 adds “1” to the total number of steps recorded in the RAM 109 every time when the estimated number of steps increases by “1”. The CPU 107 records the obtained total number of steps to the present in the RAM 109, and displays the same on the display unit 110. The CPU 107 generates the number of steps information indicating the total number of steps after the addition and causes the display unit 110 to display. The walking estimation process is performed until the walking detection process is started (walking detection ON). Subsequently, the procedure goes to Step S217.

(Step S217) The CPU 107 determines whether or not the output from the timer 104-1 is high (H) to determine whether or not the downtime during stable walking has elapsed since the counting is started in Step S201. When it is determined that the downtime during stable walking is elapsed (Yes), the procedure goes to the process in Step S218. In contrast, when it is determined that the downtime during stable walking is not elapsed (No), the procedure goes back to the process in Step S217.

The processes from Step S218 to Step S220 are the same as the processes from Step S201 to Step S203. However, it is different in that the procedure goes to Step S216 when the result of determination of Step S220 is (Yes) and to Step S221 when the result of determination is (No).

(Step 221) The CPU 107 causes the walking detecting unit to stop the walking detection process. The walking detecting unit 10 stops the supply of power to the accelerator sensor 101 and the comparator 102, and stops the walking detection process (walking detection OFF).

In a series of steps from Step S216 to Step S221, the CPU 107 performs the counting of the number of steps in the downtime during stable walking. The CPU 107 repeats the walking detection process for 5 seconds and the walking estimation process for 20 seconds.

In this embodiment, although the downtime during stable walking is set to 20 seconds, the downtime during stable walking may be increased to 30 seconds, 40 seconds, and the like with the increase in stable walking time. It is also possible to fix the sum of the uptime and the downtime constant, for example, 30 seconds, and the ratio between the uptime and the downtime may be changed. In addition, when the walking signal is not detected after having elapsed the downtime during stable walking, a value obtained by multiplying the value of the average walking speed obtained from the number of steps during the walking detection process before the downtime by half the downtime during stable walking may be employed as the estimated value of the number of steps in the downtime during stable walking.

In this manner, according to this embodiment, the walking detecting unit is always operated intermittently at the time of detection of the starting of the walking action, at the time of detection whether or not the walking action is stabilized, and at the time of stable walking. Accordingly, the activation time of the walking detecting unit can be reduced to 20% by causing the walking detecting unit to operate for 5 seconds and stop for 20 seconds, for example, during stable walking in comparison with a case where the walking detecting unit is constantly operated. Therefore, reduction of power consumption is achieved.

The entire or part of the functions of the respective components provided in a notification control device in the respective embodiments described above may be realized by recording a program for realizing these functions in a computer readable recording medium and causing a computer system to read the program recorded in the recording medium and execute the program. The term “computer system” described here includes OS or hardware such as peripheral equipment.

The term “computer readable recording medium” means portable media such as flexible disks, magneto-optic disks, ROMs, and CD-ROMs, and memory devices such as hard disk integrated in the computer system. Also, the term “computer readable recording medium” may include those which hold the program dynamically for a short time like networks such as internet, or communication lines used for transmitting the program via a communication network such as telephone lines, and those which hold the program for a certain period such as a volatile memory in the interior of the computer system which becomes a server or a client in that case. The above-described program may be those which realize part of the above-described functions, and may be those which can realize the above-described functions in combination with the program already recorded in the computer system.

Although an embodiment of the invention has been described in detail with reference to the drawings as described above, detailed configurations are not limited to those described above, and may be modified in design variously without departing the scope of the invention.

What is claimed is:

1. A number of steps counting apparatus comprising a number of steps counting unit configured to estimate the number of steps in a time period during which counting of the number of steps during walking is stopped on the basis of the number of steps counted during a time period during which the number of steps during walking is counted, and add the estimated number of steps to a total number of steps.

2. The number of steps counting apparatus according to claim 1, wherein the number of steps counting unit counts the number of steps during a first period and stops counting of the number of steps during a second period, the first period and the second period being repeated alternately.

3. The number of steps counting apparatus according to claim 2, wherein the number of steps counting unit elongates the second period when the number of continuous steps are counted in a predetermined period.

4. The number of steps counting apparatus according to claim 2, wherein the number of steps counting unit displays a total number of steps obtained by adding the estimated number of steps to the number of steps in the first period.

5. The number of steps counting apparatus according to claim 3, wherein the number of steps counting unit displays a total number of steps obtained by adding the estimated number of steps to the number of steps in the first period.

6. The number of steps counting apparatus according to claim 2, wherein the number of steps in the second period is estimated by multiplying the value obtained by dividing the number of steps counted during the first period by the first period by the second period.

7. The number of steps counting apparatus according to claim 3, wherein the number of steps in the second period is estimated by multiplying the value obtained by dividing the number of steps counted during the first period by the first period by the second period.

8. The number of steps counting apparatus according to claim 4, wherein the number of steps in the second period is estimated by multiplying the value obtained by dividing the number of steps counted during the first period by the first period by the second period.

9. The number of steps counting apparatus according to claim 5, wherein the number of steps in the second period is estimated by multiplying the value obtained by dividing the number of steps counted during the first period by the first period by the second period.

10. An electronic apparatus comprising the number of steps counting apparatus according to claim 1.

11. An electronic apparatus comprising the number of steps counting apparatus according to claim 2.

12. An electronic apparatus comprising the number of steps counting apparatus according to claim 3.

13. An electronic apparatus comprising the number of steps counting apparatus according to claim 4.

14. An electronic apparatus comprising the number of steps counting apparatus according to claim 5.

15. A pedometer comprising the number of steps counting apparatus according to claim 1.

16. A pedometer comprising the number of steps counting apparatus according to claim 2.

17. A pedometer comprising the number of steps counting apparatus according to claim 3.

18. A pedometer comprising the number of steps counting apparatus according to claim 4.

19. A pedometer comprising the number of steps counting apparatus according to claim 5.

20. A program for causing a computer of the number of steps counting apparatus to execute a procedure, the procedure including: estimating the number of steps in a period in which counting of the number of steps during walking is stopped on the basis of the number of steps counted in a period in which the number of steps during walking is counted, and adding the estimated number of steps to the total number of steps.
